(19) United States
(12) Patent Application Publication
(10) Pub. No.: US 2026/0042097 A1
(43) Pub. Date: Feb. 12, 2026

(54) INSTRUMENT WITH INTEGRATED CLAMP AND LATCH WITH CAM OPTIMIZED FOR MULTIPLE CONSUMABLE HEIGHTS

(71) Applicant: Bio-Rad Laboratories, Inc., Hercules, CA (US)

(72) Inventors: Jeffry CEREMONY, Hercules, CA (US); Michael SCHNEIDER, Hercules, CA (US); Garret BAUTISTA, Hercules, CA (US)

(21) Appl. No.: 18/995,717

(22) PCT Filed: Jul. 19, 2023
(86) PCT No.: PCT/US2023/028108

§ 371 Date: Jan. 16, 2025

Related U.S. Application Data
(60) Provisional application No. 63/391,381, filed on Jul. 22, 2022.

(51) Int. Cl. B01L 3/00; B01L 7/00

(52) U.S. Cl. CPC B01L 3/50851; B01L 3/50853; B01L 7/52; B01L 2200/025; B01L 2200/16; B01L 2300/043; B01L 2300/14; B01L 2300/18

(57) ABSTRACT

An instrument (e.g., a thermal cycler) includes a consumable compartment configured to receive multiple height consumables, and a lid for opening or closing the consumable compartment. The lid includes a motor, a pressure plate, a compression bar, and a cam and a follower. The compression bar has a first side (e.g., bottom) coupled to the pressure plate and a second side (e.g., top) at which the cam and the follower is disposed. The cam is drivably coupled to the motor and the follower is coupled to the compression bar to induce translation of the compression bar when engaged with the cam. The cam includes a cam profile configured to adjust a height of the pressure plate between different height consumables to apply a pre-determined pressure. The motor can also operate a latch assembly to latch the lid before activating the cam and follower assembly.

### CROSS-REFERENCES TO RELATED APPLICATIONS

This application claims priority to U.S. Provisional Application No. 63/391,381, filed Jul. 22, 2022, the disclosure of which is hereby incorporated by reference in its entirety for all purposes.

### FIELD OF DISCLOSURE

The present disclosure relates to laboratory equipment used for performing sequential chemical reactions e.g., the polymerase chain reaction (PCR). In particular, the present disclosure relates to thermal cyclers configured to receive reaction vessels of different heights and lids configured to adjust to different heights of the reaction vessels.

### BACKGROUND

Certain chemical reactions involve thermal cycling of samples in an instrument such as thermal cyclers configured to control temperatures at different stages of a chemical process. For example, the polymerase chain reaction (PCR) is one of many examples of chemical processes that require precise temperature control of reaction mixtures with rapid and precise temperature changes between different stages of the process. PCR itself is a process for amplifying DNA, i.e., producing multiple copies of a DNA sequence from a single strand bearing the sequence. There are various versions of PCR. For example, PCR can involve cycling between two temperatures for denaturing of a template, annealing of primers, and an extension of a new copy. Reagent transfer is via a liquid handler. Optical detection can be used for real-time PCR. PCR is typically performed in instruments that provide reagent transfer, temperature control, and optical detection in a multitude of reaction vessels such as wells, tubes, or capillaries. The process includes a sequence of steps that are temperature-sensitive, different steps being performed at different temperatures and the sequence being repeated a multitude of times to obtain a quantity large enough for analysis and study from an extremely small starting quantity.

In the typical PCR instrument, either a multi-well plate (usually one with 96 wells in an 8×12 array, but often ones with larger or smaller numbers of wells) with a sample in each well or a series of individual plastic tubes is placed in contact with the thermal block. The thermal block is heated and cooled either by a Peltier heating/cooling apparatus, which may be a single Peltier module or an array of modules, or by a closed-loop liquid heating/cooling system that circulates a heat transfer fluid through channels machined into the block. In either case, the heating and cooling of the thermal block is typically under the control of a computer (e.g., firmware in an on-board controller chip) with input from the operator. The instrument may also be run in stand-alone mode without use of the computer. The thermal block makes intimate contact with the plate wells or the tubes to achieve maximal heat transfer. The reaction vessels, whether they be a plate or individual tubes, are usually plastic which itself is not a medium of high thermal conductivity. The plastic itself, plus the interface between the plastic and the metallic thermal block, produces thermal resistance which must be reduced or at least controlled to achieve efficient heat transfer between the thermal block and the reaction media. Reduction and control of the thermal resistance can be achieved by applying force to the vessels to press the vessels against the corresponding depressions in the thermal block. The force must be applied evenly to achieve uniform temperature control and minimal thermal resistance. The force elements may be coupled to a heater to minimize condensation. The same force also serves to help seal the vessels during the thermal cycling and to maintain the seal during the pressure changes that result from the heating and cooling stages of the thermal cycling. The force must be adequate to serve all of these purposes, and the thermal cycler, which term is commonly used to denote the instrument in which the entire PCR process is performed, must also be able to accommodate reaction tubes or plates of different heights.

### BRIEF SUMMARY

One aspect of the present disclosure relates to an instrument for performing chemical process, for example, a thermal cycler for performing PCR. Biological samples or other chemical samples may be stored or transported using consumables, which can have a large range of consumable heights. An instrument (e.g., used in PCR) typically cannot accommodate multiple height consumables in the same instrument, and different instruments may be needed for different consumables. The present disclosure provides a lid with an adjustable pressure plate operated by a cam and follower mechanism to facilitate use of multiple height consumables in the same instrument. Also, a latch mechanism may be provided that can be driven by the same driving means used for the cam and follower mechanism thereby enabling a compact lid design which facilitate accommodation of a single consumable or consumables of different heights.

In many embodiments, an optimized cam is designed to increase the pressure angle between large gaps of consumable heights and decrease the angle when in contact with consumables to minimize both the required spaced needed and the torque required by the motor to clamp on consumables. The cam shaft is directly attached to a motor shaft or attached by flexible coupling, and the shaft is supported in two areas. At the far end of the shaft away from the motor is coupled with a latch actuator (e.g., a wheel with a ramp). An initial portion of the cam's profile is designed to disengage from its follower at the beginning of its rotation so that the same motor can actuate and retract a front latch to allow the lid to rotate open. The optimized cam allows the instrument to move from one consumable height to another at a sharp angle, but levels off for each of the consumable heights, thus allowing the use of a smaller motor in a compact size. With the latch activation built into the cam circular motion, one motor can be used for both actions.

Thus, according to an aspect, an instrument for receiving multiple height consumables is described. For example, the instrument is a thermal cycler used for PCR. The instrument includes a consumable compartment and a lid. The consumable compartment is configured to receive first height consumables having a first height or second height consumables having a second height, tops of the first height consumables defining a first plane when the first height consumable are received within the consumable compartment, and tops of the second height consumables defining a second plane when the second height consumables are received within the consumable compartment In many embodiments, the lid includes a motor, a pressure plate, a compression bar, and a cam and follower assembly. The compression bar having a first side and a second side opposite to the first side, wherein the first side is coupled to the pressure plate. The cam and follower assembly is disposed on the second side of the compression bar. The cam is drivably coupled to the motor and the follower is coupled to the compression bar to induce translation of the compression bar when engaged with the cam. The cam includes a cam profile with a follower engaging portion configured to adjust a height of the pressure plate within the consumable compartment between the first plane and the second plane and drive the compression bar to apply a pre-determined pressure at the first plane, the second plane, or a plane therebetween. In many embodiments, the cam profile comprises a follower non-engaging portion where the follower is disengaged from the cam while the cam rotates.

In many embodiments, the cam profile is optimized to minimize required torque input from the motor and to accommodate multiple consumable heights while providing for a minimized height profile of the cam. In many embodiments, the cam profile comprises radii of curvatures and pressure angles configured to operate the cam and the follower at approximately a constant torque provided by the motor. In many embodiments, the cam profile is configured to move the pressure plate by (i) a first distance from a rest plane of the pressure plate at a first rate and at a pre-determined torque provided by the motor, and (ii) a second distance from the rest plane at a second rate and at the pre-determined torque provided by the motor so as to enable the instrument to receive the first height consumables or the second height consumables.

In many embodiments, the cam profile is a continuous profile including a first portion, and a second portion following the first portion. The first portion and the second portion are configured to engage with the follower during adjusting of the height of the pressure plate to the first plane. The cam profile further includes a third portion configured to cause the pressure plate to translate at a faster rate than translation caused by the first portion or the second portion. The cam profile further includes a fourth portion having varying pressure angles and radius of curvatures to apply an approximately constant torque at the second plane or planes between the first plane and the second plane.

The first portion of the cam profile is a dwell portion extending from approximately 0° from a start of the cam profile to approximately 50° from the start of the cam profile, wherein a radius of curvature of the first portion gradually increases from start of the cam profile to an end of the first portion such that as the follower travels from the start of the first portion to end of the first portion, the pressure plate one of: remains stationary; or moves less than 2 mm towards the first plane. The second portion of the cam profile extends from approximately 50° from the start of the cam profile to approximately 90° from the start of the cam profile, where a radius of curvature of the second portion gradually increases such that as the follower travels along the second portion, the pressure plate moves towards the first plane and contacts the tops of the first height consumables defining the first plane. The second portion further includes a clamping portion having a radius of curvature and/or a pressure angle defined as a function of a specified torque of the motor. The clamping portion operates at a constant torque or same torque for all consumable heights. For example, the torque applied by the motor at the pressure plate to apply the pre-determined pressure at the first height consumable is the same as the torque required to apply the pre-determined pressure at the second height consumable. The third portion of the cam profile extends from approximately 90° from the start of the cam profile to approximately 165° from the start of the cam profile from a start of the cam profile, wherein a radius of curvature of the third portion gradually increases such that as the follower travels along the third portion, the pressure plate moves towards the second plane and comes in contact with the second plane. The third portion has a pressure angle greater than a pressure angle of the first portion and/or the second portion to allow a faster travel rate of the follower to cover a distance between the first plane and the second plane compared to an earlier travel rate before reaching the first plane. The fourth portion extends from approximately 165° from the start of the cam profile to approximately 300° from the start of the cam profile. The fourth portion further includes a fifth portion having an approximately constant radius to avoid the follower disengaging from the cam, wherein the fifth portion spans between approximately 295° to 300°.

In many embodiments, the cam is coupled to a motor/cam shaft extending perpendicular to a translation direction of the pressure plate. The motor/cam shaft further includes a hard stop located between the cam and the motor along the motor shaft to prevent the cam from rotating beyond the follower engaging profile when the pressure plate is traveling beyond the second plane.

In many embodiments, the lid further includes a calibrated sensor, and a controller.

The calibrated sensor is configured to send a signal indicating a position at which the pre-determined pressure is applied by the pressure plate. The controller is configured to control, based on the signal from the calibrated sensor, deactivation of the motor to prevent the cam from further rotating and advancing the pressure plate. The lid further includes a heater coupled to the pressure plate to heat a surface of the pressure plate facing the consumable compartment.

In many embodiments, the lid further includes a latch and a latch actuator. The latch is operably coupled to the cam and the follower assembly such that the cam and follower assembly is activated after latching of the lid. The latch actuator is configured to move the latch between a latched position to an unlatched position. The latch actuator and the cam are mounted on the same motor shaft and driven by the same motor.

In many embodiments, the motor shaft includes a first end and a second end. The first end is driveably coupled to the motor. The cam is coupled to the motor shaft between the first end and the second end. The cam is driven by the motor to cause translation of the follower. The latch is actuator coupled to the motor shaft at the second end. The latch actuator includes a profiled portion extending axially and radially at least partially along a peripheral surface of the latch actuator. The latch actuator is coupled to the motor shaft such that the profiled portion at least partially aligns with the follower engaging portion. The latch includes a latch wheel configured to cooperate with the profiled portion to cause the latch to be in an unlatched state while the cam is disengaged from the follower.

In many embodiments, the latch comprises an elongated portion extending transversely in a vertical direction with respect to the motor shaft and a pivot portion about which the elongated portion pivots. The elongated portion includes a catch, a first end, a second end. The latch wheel is disposed at the first end and the catch is disposed at the second end. The pivot portion is between the first end and the second end. The profiled portion of the latch actuator has a ramp profile extending axially away from the cam and inclined with a center of rotation of the motor shaft. The latch wheel is configured to travel along the ramp profile causing the elongated portion to pivot about the pivot portion and move the catch so that the latch is in the latched state or the unlatched state.

In many embodiments, the lid further includes a rod coupled at the pivot portion of the latch to manually pivot the latch. The rod comprises a tool receiving slot to receive a tool for rotating the rod. Further, a spring is disposed at the pivot portion to pre-load the latch to move the latch in the latched state when the latch wheel is disengaged from the profiled portion. The spring is a torsional spring. The latch wheel disengages from the profiled portion of the latch to move the latch to the locked state. In the locked state, the follower engaging portion of the cam profile engages with the follower. In the locked state of the latch, the follower engaging portion of the cam profile is configured to move the follower between a first distance and a second distance.

The forgoing general description of the illustrative implementations and the following detailed description thereof are merely exemplary aspects of the teachings of this disclosure, and are not restrictive.

### BRIEF DESCRIPTION OF THE DRAWINGS

The accompanying drawings, which are incorporated in and constitute a part of the specification, illustrate one or more embodiments and, together with the description, explain these embodiments. The accompanying drawings have not necessarily been drawn to scale.

Any values dimensions illustrated in the accompanying figures are for illustration purposes only and can or cannot represent actual or preferred values or dimensions. Where applicable, some or all features cannot be illustrated to assist in the description of underlying features. In the drawings:

FIG. 1A illustrates a thermal cycler, in accordance with some embodiments of the present disclosure.

FIG. 1B and FIG. 1C illustrate different height consumables deploy able in the thermal cycler of FIG. 1A.

FIG. 2 illustrates components in a lid of the thermal cycler of FIG. 1A.

FIG. 3 illustrates a cam and a follower disposed in the lid of FIG. 2.

FIG. 4 is an exploded view illustrating the cam and follower assembly, and a compression bar assembly and a pressure plate disposed within the lid of FIG. 2.

FIG. 5 illustrates a perspective view of the cam coupled to a motor shaft that is disposed in the lid of FIG. 2.

FIG. 6A is an exploded view of the compression bar assembly and a pressure plate disposed in the lid of FIG. 2.

FIG. 6B is an assembled view of the compression bar assembly and a pressure plate disposed in the lid of FIG. 2.

FIG. 7A is an exploded view illustrating a variation of components in the lid including a compression bar assembly, the cam and follower assembly, and control board assembly disposable within the lid of FIG. 2.

FIG. 7B is an exploded view of the compression bar assembly of FIG. 7A.

FIG. 8 is a perspective cross-section view illustrating the cam and the follower for moving the compression bar assembly in the lid of FIG. 2.

FIG. 9 is a front cross-section view of the lid of the thermal cycler of FIG. 1A illustrating different planes for adjusting height of a pressure plate.

FIG. 10 is a cross-section view of the lid of FIG. 2 illustrating the cam rotated to an initial position and a pressure plate in a rest position.

FIG. 11 is a cross-section view of the lid of FIG. 2 illustrating the cam rotated to a first position and the pressure plate moved to the first plane corresponding to a first height consumables.

FIG. 12 is a cross-section view of the lid of FIG. 2 illustrating the cam further rotated from FIG. 11 to compress the first height consumables.

FIG. 13 is a cross-section view of the lid of FIG. 2 illustrating the cam rotated to engage a dwell portion of the cam before moving from the pressure plate the first height consumables to a next height consumables.

FIG. 14 is a cross-section view of the lid of FIG. 2 illustrating the cam rotated to a second position and the pressure plate moved to the second plane corresponding to a second height consumables.

FIG. 15 is a cross-section view of the lid of FIG. 2 illustrating the cam further rotated from FIG. 14 to compress the second height consumables.

FIG. 16 is an exploded view of an example latch.

FIG. 17 illustrates one embodiment of a latch actuator of the lid in FIG. 2.

FIG. 18 illustrates the latch actuator of FIG. 17 engaged with the latch of FIG. 16.

FIG. 19 is a cross-section view showing movement of the latch of FIG. 16.

FIG. 20 illustrates manually opening of a closed lid of FIG. 2.

FIG. 21 illustrate manually opening of the closed lid comprising the latch of FIG. 16.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

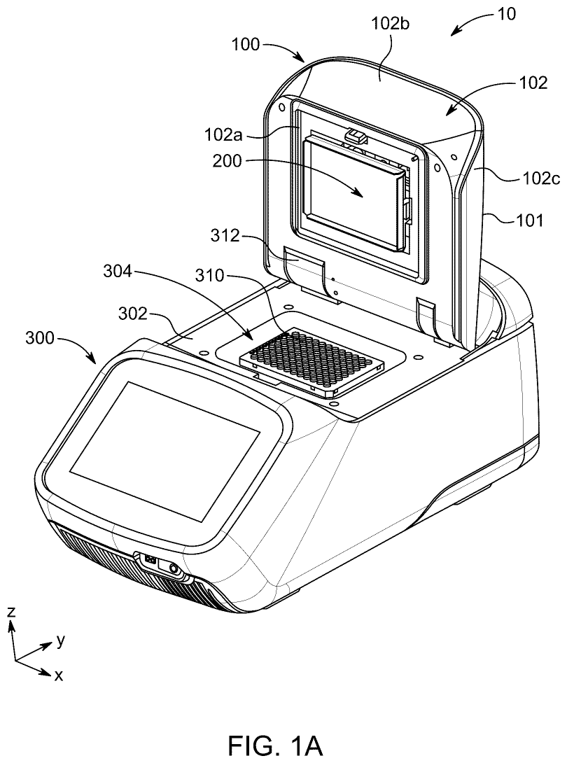

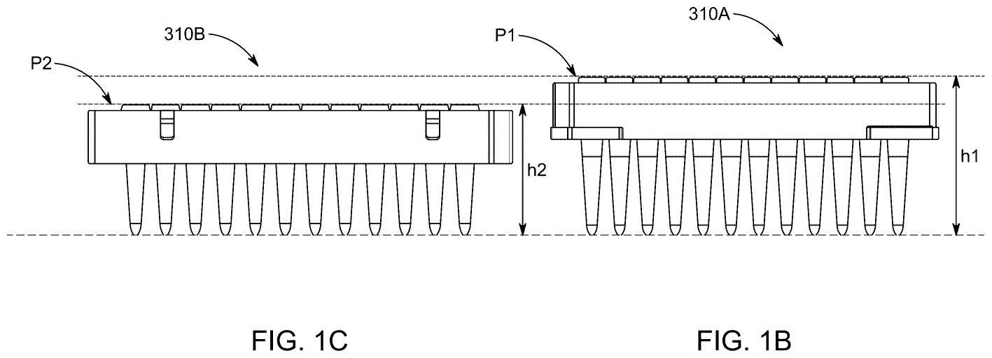

FIG. 1A illustrates an instrument for performing chemical reaction and configured to receive multiple height reaction vessels. For example, the instrument may be a thermal cycler embodying the features of the present disclosure. The present disclosure discusses the concepts with reference to thermal cycler, as an example, but the concepts herein can be applied to any instrument with a lid including an adjustable height pressure plate. A thermal cycler 10 can include a lid 100, a pressure plate 200 disposed in the lid 100, and a base 300. The lid 100 can be coupled to the base 300 and can be latched or unlatched to the base 300. In some embodiments, the lid 100 is coupled to the base 300 by a hinge assembly 312, which may include a torsional spring, a bearing-supported hinge motor, and integrated sensor flags operating in conjunction with optical sensors to detect when the lid 100 is open or closed.

Alternatives to the hinge assembly are any connectors that permit raising and lowering of the lid 100 over the base 300.

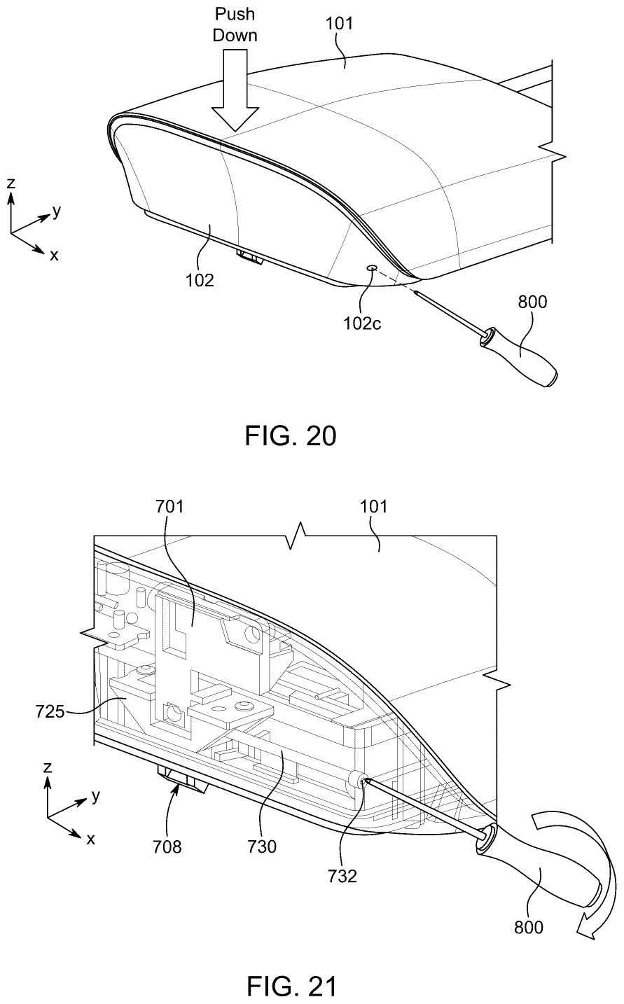

The lid 100 can include a lid cover 101 coupled to a lid chassis 102 to form an enclosed portion within which components of the present disclosure can be disposed. The lid cover 101 can be a top cover and can provide an internal mounting surface for several components such as a control board and/or sensors within the lid 100. Similarly, the lid chassis 102 can provide means for mounting several components of the present disclosure, as will be apparent from the figures and discussion below. The lid chassis 102 can include a bottom surface 102a and side walls 102b coupled to the lid cover 101. The bottom surface 102a can include an opening for accessing the pressure plate 200 and allowing the pressure plate 200 to translate. In some embodiments, when the lid 100 is closed, the bottom surface 102a engages, via surrounding seal, with a top surface of a deck portion 302 of the base 300 and the pressure plate 200 can translate from the lid 100 into a compartment 304 of the base 300 to engage with a reaction vessel 310 therein. The pressure plate 200 can be actuated using a cam and a follower mechanism further discussed in detail below. In some embodiments, a front portion of the side walls 102b includes a latch access hole to manually open or close the lid 100. The manual operation of the latch is further discussed in detail with respect to FIG. 20 and FIG. 21.

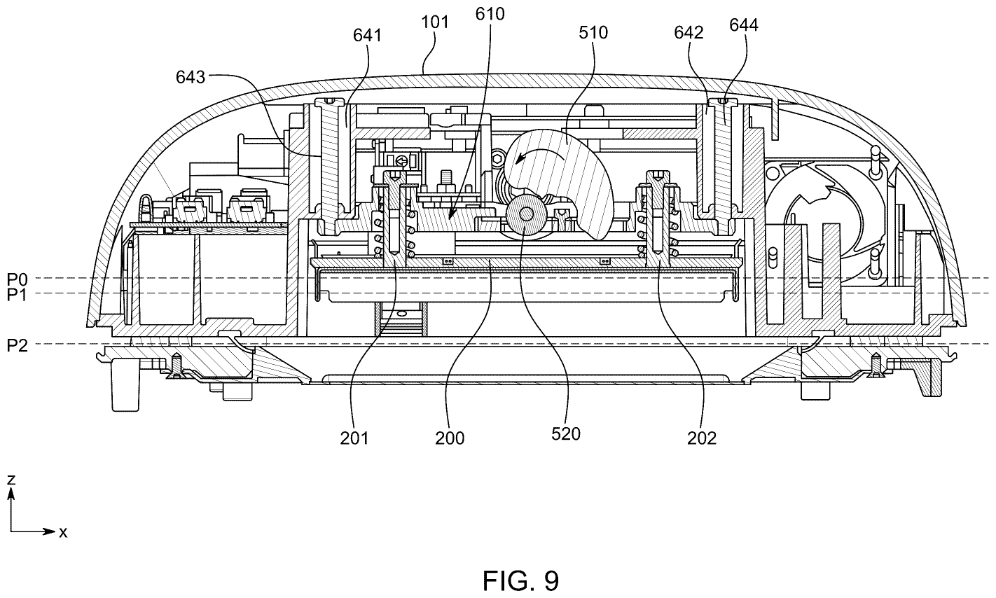

Referring to FIG. 1A, the base 300 can include the deck portion 302 configured to engage with an underside of the lid 100. The deck portion 302 can be a flat portion having an opening on a top side and may further include a curved portion conforming to a shape of front side of the side walls 102b of the lid 100 and having an opening. The compartment 304 can extend toward a bottom side of the base 300 and accessible through the opening in the deck portion 302. The compartment 304 can receive a vessel such as the reaction vessel 310 configured to carry samples to be processed by the thermal cycler 10. The compartment 304 or the reaction vessel 310 placed in the compartment 304 can be configured to receive vessel types of different heights such as a tallest height reaction vessel, a shortest height reaction vessel, or any other reaction vessel of intermediate heights. For example, a first height reaction vessel (e.g., a first height consumable) can include multiple wells, tubes or other vessels of same height (e.g., a first height h1) and the second height reaction vessel (e.g., a second height consumable) can include multiple wells, or tubes of another same height (e.g., a second height h2). For example, FIG. 1B illustrates a first height consumable 310A with multiple tubes of height h1 and FIG. 1C illustrates a second height consumable 310B with multiple tubes of height h2, which is smaller than the height h1. When a reaction vessel 310 is placed in the compartment 304 of the thermal cycler 10, top of the reaction vessel corresponds to a plane within the compartment 304. The reaction vessel 310 is referred as a consumable 310, hereafter without limiting the scope of the present disclosure. The consumable 310 can be disposed after use. For example, FIG. 9 illustrates different planes within the compartment 304.

As shown in FIG. 9 and FIGS. 1B-1C, tops of the first height consumable 310A define a first plane P1 when a first height consumable is received within the compartment 304. Similarly, tops of the second height consumable 310B define a second plane P2 when a second height consumable is received within the consumable compartment 304. As an example, the first plane P1 may correspond to a tallest height consumable, and the second plane P2 may correspond to a shortest height consumable. The present disclosure is not limited to a particular reaction vessel. In some embodiments, a thermal block (not shown) may be included in the base 300 to heat and cool the consumable 310 from underneath.

Referring back to FIG. 1A, the pressure plate 200 can press against the consumable 310 to apply a pre-determined pressure thereon. For example, in a thermal cycler, the pressure plate 200 can press the consumable 310 against a thermal block (not shown) and heat the tops of the vessel. The pressure plate 200 can be supported by the lid 100 and has a downwardly facing central platform that directly contacts the consumable.

The thermal cycler 10 can further include additional components such as sensors, controllers, interface, buttons, or other components disposed in the lid 100 or the base 300 to provide support and control of a thermal cycle (e.g., related to PCR) to be applied to a consumable. For example, a thermal cycler and additional components are discussed in U.S. Pat. No. 8,784,753, which is incorporated by reference in its entirety.

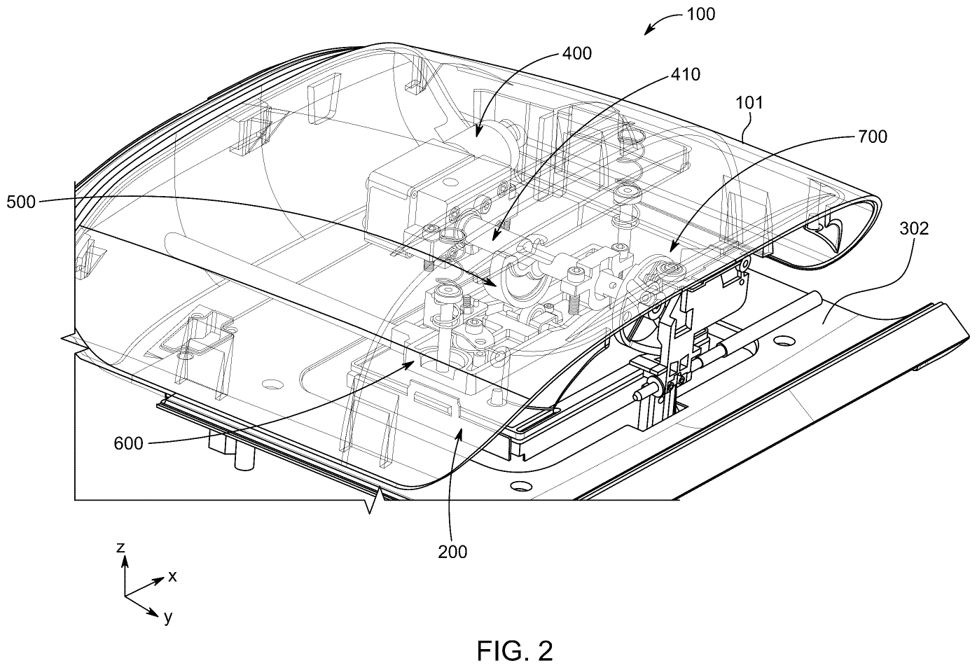

FIG. 2 illustrates components of the present disclosure disposed in the lid 100 according to some embodiments. The lid cover 101 is shown as transparent to better show the components therein, the chassis 102 is removed, and some other components are omitted in the illustration to better focus on concepts of the present disclosure. In one embodiment, as shown in FIG. 2, the lid 100 can include a motor 400, a cam and a follower assembly 500, a compression bar assembly 600, and a latch assembly 700. The motor 400 can drive the cam and follower assembly 500 to move the pressure plate 200 and cause the compression bar assembly 600 to apply a predetermined pressure (e.g., 75 lbs., 100 lbs., etc.) to the pressure plate 200. The latch assembly 700 is configured to lock/latch or unlock/unlatch the lid 100 to the deck portion 302 of the base 300. In many embodiments, the cam and follower assembly 500 applies pressure on the consumables after the lid is latched.

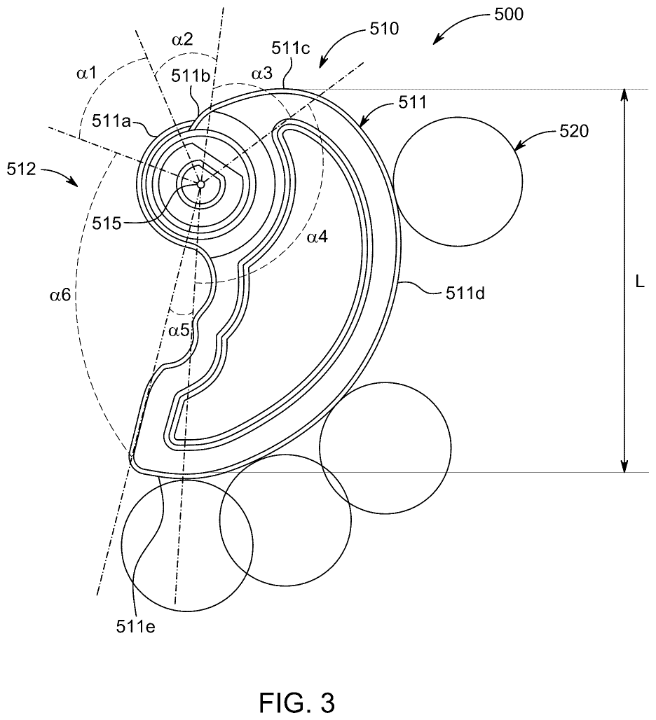

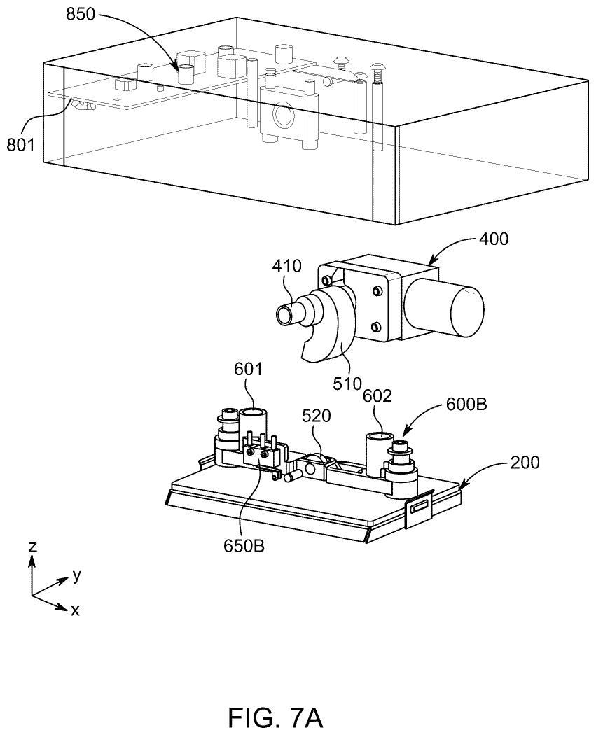

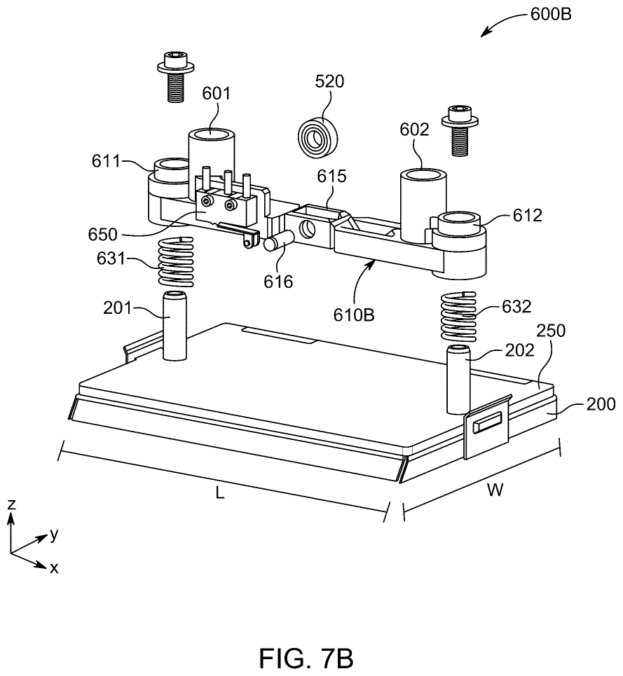

The cam and follower assembly 500 can be coupled, via the compression bar assembly 600, to the pressure plate 200 and configured to translate the pressure plate 200 e.g., in a vertical direction (e.g., z direction). The cam and follower assembly 500 can be driven by the motor 400. For example, the cam and follower assembly 500 can include a cam 510 and a follower 520 (e.g., see FIG. 3 and FIG. 7). The cam 510 can be coupled to a motor shaft (alternatively referred to as a cam shaft) 410 and driven by the motor 400. The motor shaft 410 can be coupled to the motor 400 via a gear mechanism (e.g., a worm gear) to achieve a desired rotation speed of the cam 510 and torque at the cam 510.

The compression bar assembly 600 includes a first side (e.g., a bottom side) and a second side (e.g., a top side) opposite to the first side. The first side can be coupled to the pressure plate 200 and the second side can be configured to apply the pre-determined pressure to the pressure plate 200. The cam and follower assembly 500 can be disposed on the second side of the compression bar assembly 600 to apply a downward force on the compression bar assembly 600. Upon rotating the motor 400, the cam and follower assembly 500 applies force on the second side of the compression bar assembly 600, which further transmits a pressure to the pressure plate 200.

Advantageously, the cam and follower assembly 500 enables the motor 400 to operate at an approximately constant torque thereby improving the reliability and longevity of the motor 400 and the lid 100. It can be appreciated that a thermal cycler may be opened and closed several hundreds, thousands, or more number of times and operate for hundreds or more number of cycles, as such operating at constant torque (e.g., same torque applied at different consumable heights) is highly beneficial to reduce wear and tear of the motor.

Particularly, the motor runs at a very low torque until it reaches a consumable and only increases the torque to apply pre-determined pressure. In some embodiments, a cam of the cam and follower assembly 500 is optimized such that a small sized motor (e.g., having reduced power and torque requirements compared to existing motors used in thermal cyclers) can be used to open or close the lid 100 thereby facilitating a compact sized lid design. For example, a motor can be a small motor, e.g., having a maximum power of 20 W or less, a diameter of approximately 24 mm or less, and can produce a torque of approximately 40 mN-m or less. Thus, a cam profile is optimized to apply desired amount of pressure even with a small motor to advantageously make the lid 100 compact. However, it can be understood that the present disclosure is not limited by the type or power of the motor. A more powerful motor (e.g., greater than 20 W), a slower motor with a smaller gear reduction delivering more torque may be employed. A shorter lid may employ a cam with larger pressure angle along with a high power or high torque motor.

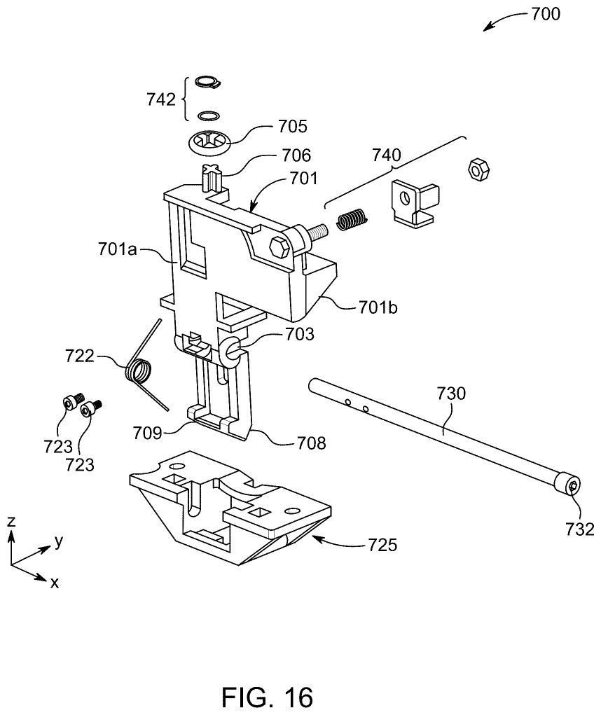

In some embodiments, the same motor 400 can be used to drive the latch assembly 700 to open or close the lid 100. Thus, eliminating the need of additional motor for latching purpose thereby facilitating a more compact lid design. The latch assembly and its operation are discussed in more detail with respect to FIGS. 16-21. Advantageously such dual-purpose motor can facilitate a fully automatic operation of the lid 100 or the thermal cycler 10. For example, a robotic arm (not shown) can place the consumable 310 (see FIG. 1A) in the compartment 304 and a hinge motor can be rotated to close the lid 100, the motor 400 can be actuated to the latch the lid 100, and the motor 400 can be further rotated to adjust the height of the pressure plate 200 to apply a predetermined pressure on the consumable 310. After the predetermined pressure is reached, thermal cycling related to PCR can be activated. After completing the PCR process, the motor 400 can be actuated to retract the pressure plate 200 and unlatch the latch assembly 700. The lid 100 can then be opened and the consumable 310 can be removed by the robotic arm from the compartment 304 (see FIG. 1A).

FIG. 3 illustrates an example of the cam and follower assembly 500 including a cam 510 and a follower 520 that facilitates adjusting of height of the pressure plate 200 and apply a pressure to multiple height consumables. The cam 510 can include a cam profile with a follower engaging portion 511. In many embodiments, the cam profile can also include a follower non-engaging portion 512 where the follower 520 is disengaged from the cam 510. The follower non-engaging portion 512 can operate in cooperating with a latch assembly used to latch/unlatch the lid 100, which is further explained with respect to FIGS. 16-21.

In FIG. 3, the follower engaging portion 511, also referred as the cam profile portion, includes a curved portion with varying radius of curvature along which the follower 520 stays engaged while the cam 510 rotates. In many embodiments, the cam profile portion 511 is optimally designed to increase a pressure angle between large gaps (e.g., between the first plane P1 and the second plane P2) of consumable heights and decrease the pressure angle when in contact with consumable to minimize both space occupied by the cam 510 and the torque to be applied on the cam 510 by the motor 400 to clamp on the consumable. The cam profile portion 511 advantageously facilitates design of compact lid of an instrument such as the thermal cycler 10. For example, the cam profile portion 511 is curved which minimizes a vertical space occupied by the cam 510 within the lid 100. Within the minimized vertical space, the cam 510 can rotate and push the follower 520 downward thereby creating space while in operation. The additional space created further allows the cam 510 to rotate further and push the follower downward achieving a compact cam design within a small space of the lid 100.

The follower engaging portion 511 can be curved to have a variable radius of curvature, where the radius of curvature is determined as a function of adjustment heights corresponding to multiple height consumables and/or a torque. For example, the follower engaging portion 511 can be optimized based on a function of a distance (e.g., between different planes P0, P1, and P2 in FIG. 9) to be travelled by the pressure plate 200 and a torque to be applied by the motor 400. For example, the cam profile is optimized to minimize required torque input from the motor 400 and to accommodate a single or multiple consumable heights while providing for a low overall height profile. For example, the follower engaging portion 511 includes a first curve to adjust a height of the pressure plate 200 within the compartment 304 between the first plane (e.g., P1 in FIG. 9) and the second plane (e.g., P2 in FIG. 9) and a second curve (e.g., having decreased radius of curvature than the first curve) to drive the compression bar assembly 600 to apply the pre-determined pressure (e.g., 75 lbs, 100 lbs, etc.) at the first plane (e.g., P1) or the second plane (e.g., P2). In many embodiments, the cam profile portion 511 can be configured to move the pressure plate 200 by (i) a first distance e.g., from a rest plane (e.g., P0 in FIG. 9) to the first plane (e.g., P1 corresponding to the first height consumables in FIG. 9) at a first rate and at a pre-determined torque provided by the motor 400, and (ii) a second distance from e.g., from the first plane (e.g., P1) to the second plane (e.g., P2 corresponding to the second height consumables in FIG. 9) at a second rate faster than the first rate and at the pre-determined torque provided by the motor 400. Accordingly, the cam profile portion 511 can included multiple curved portions, each portion being optimized to minimize a size of the cam 510 so that it can be accommodated within a small space in the lid 100 while achieving a desired travel distances between tallest and shortest consumables and during application of the pre-determined pressure. The optimization of the curved portion can be based on a torque parameter associated with rotating the cam 510 and application of pressure at the pressure plate 200. For example, one or more curved portions are configured to apply pressure at a constant/same torque received from the motor 400 (see FIG. 2) for different consumable heights.

In some embodiments, the cam profile can include a continuous profile. In one embodiment, as shown in FIG. 3, the cam profile portion 511 can include a first portion 511a, and a second portion 511b following the first portion 511a. The first portion 511a and the second portion 511b can be configured to engage with the follower during adjusting of the height of the pressure plate 200 from the rest position (e.g., P0 in FIG. 9) to above the first plane (e.g., P1 in FIG. 9).

The first portion 511a of the cam profile can be a dwell portion spanning an angle α1. For example, the first portion 511a may extend from approximately 0° from the start of the cam profile to approximately 50° from the start of the cam profile. A radius of curvature of the first portion 511a can be optimized to gradually increase from start of the cam profile to an end of the first portion 511a such that as the follower travels from the start of the first portion 511a to end of the first portion 511a, the pressure plate 200 remains stationary, or moves slightly (e.g., less than 2 mm) towards the first plane (e.g., P1) but does not contact with the first height consumables.

In some embodiments, the second portion 511b of the cam profile can be a portion where the pressure plate 200 comes in contact with tops of the first height consumables and further applies pressure thereon. A radius of curvature of the second portion 511b can be optimized to gradually increase such that as the follower travels along the second portion 511b, the pressure plate 200 moves towards the first plane (e.g., P1) to contacts the tops of the first height consumables defining the first plane (e.g., P1). The second portion 511b can further include a clamping portion that includes a radius of curvature defined as a function of a specified torque of the motor 400. In the clamping portion, the pressure angle decreases compared to prior portion of the second portion 511b to allow the follower 520 to travel a short distance (e.g., less than 2 mm) at a constant torque while applying pressure at the top of the first height consumables. Accordingly, the clamping portion can operate at approximately constant torque (e.g., same torque value as applied at the second height consumable) applied by the motor 400 to cause the pressure plate 200 to travel further than the first plane (e.g., P1) and apply the pre-determined pressure at the first height consumables. The second portion 511b spans an angle α2. For example the second portion 511b may extend from approximately 50° from the start of the cam profile to 90° from the start of the cam profile.

The cam profile portion 511 can further include a third portion 511c following the second portion 511b. The third portion 511c can be configured to include a dwell portion followed by a portion to cause the pressure plate 200 to translate at a faster rate than translation caused by the first portion 511a or the second portion 511b. For example, the third portion 511c has an approximately flatter portion followed by a portion with a pressure angle greater than a pressure angle of the first portion 511a and/or the second portion 511b to allow a faster travel of the follower to cover a distance between the first plane (e.g., P1) and the second plane (e.g., P2). The third portion 511c enables minimizing the size (e.g., a largest length L in FIG. 3) of the cam 510 while accommodation of multiple height consumables. The third portion 511c spans spanning an angle α3. For example, the third portion 511c may extend from approximately 90° from the start of the cam profile to approximately 165° from the start of the cam profile. The dwell portion can be between 90° to 165° or less.

The cam profile portion 511 can further include a fourth portion 511d, and/or a fifth portion 511e (also referred as a tolerance portion 511e). The fourth portion 511d can have varying pressure angles and radius of curvatures to apply an approximately constant torque (e.g., same torque value as applied at the first height consumable) at the second plane or any planes between the first plane (e.g., P1) and the second plane (e.g., P2). The fourth portion 511d spans an angle α4. For example, the fourth portion 511d may extend from approximately 165° from the start of the cam profile to approximately 300° from the start of the cam profile. The tolerance portion 511e can be an end portion of the fourth portion 511d configured to avoid the follower from disengaging the cam. For example, the fifth portion 511e has an approximately constant radius. The fourth portion 511d can span between 285° to 300°, 295° to 300°, etc.

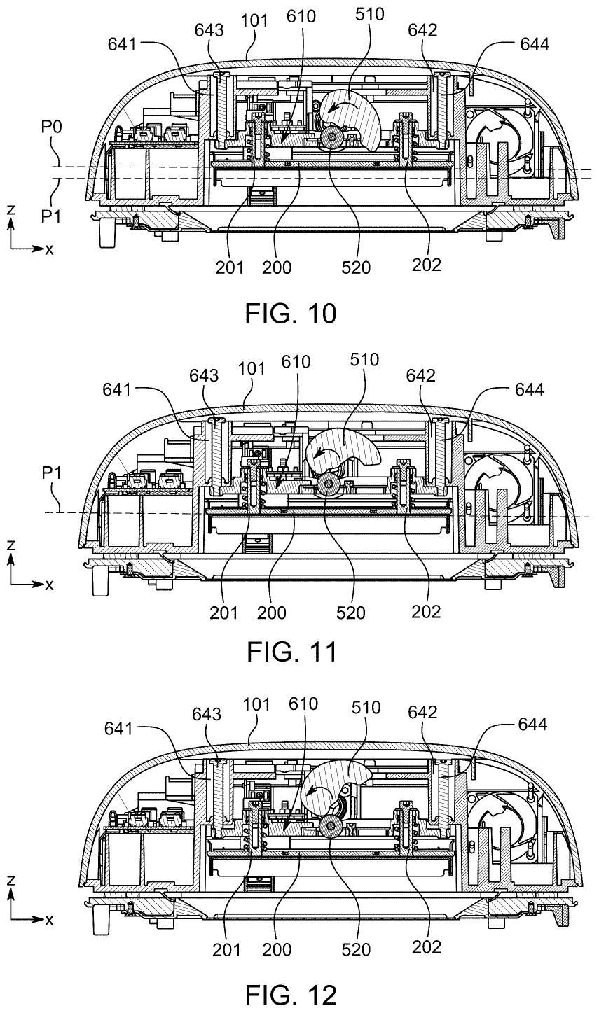

The operation of the cam and follower assembly 500 in cooperation with the motor 400, the compression bar assembly 600 and the pressure plate 200 to facilitate accommodation of consumables of different heights is further illustrated and discussed with respect to FIGS. 10-15.

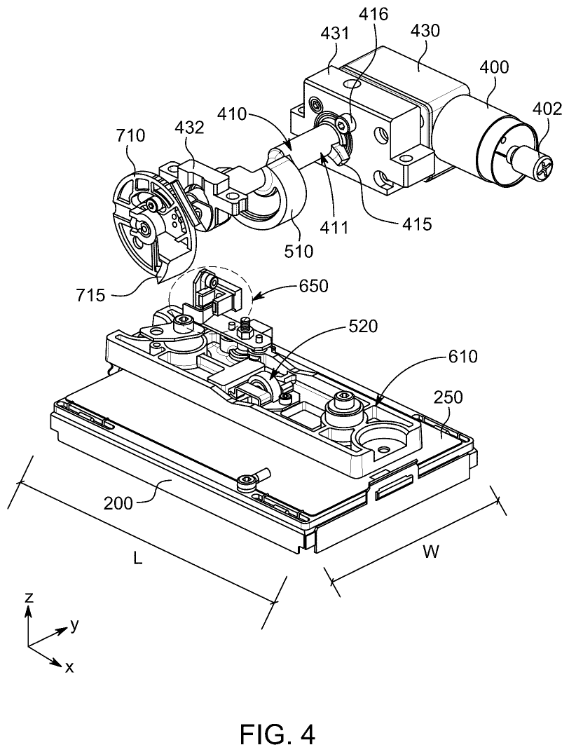

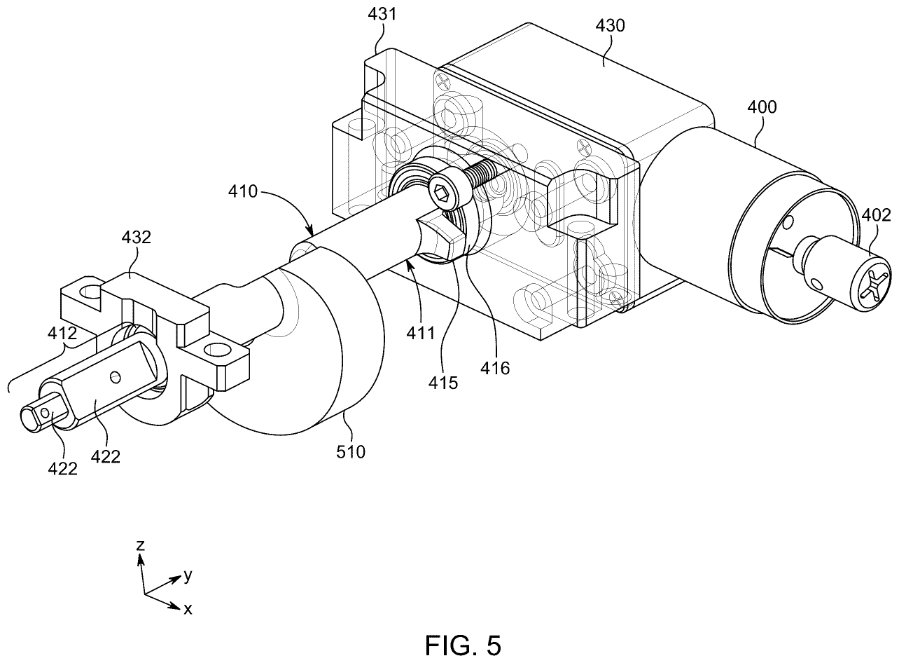

FIG. 4 illustrates an exploded view of the cam assembly 500 separated from the compression bar assembly 600 and the pressure plate 200, and FIG. 5 illustrates details of the cam and follower assembly 500 coupled to motor 400. In one embodiment, as shown in FIGS. 4 and 5, the motor 400 can be coupled to a gear box 430, which can include speed reduction gears to reduce speed of the motor 400. The gear box 430 can also increase the torque of the motor, and configured to hold the load at the associated consumable height without rotating backward. The gear box 430 also enables the motor 400 to be turned off while the desired pressure is maintained on the pressure plate 200. The reduced speed can be transmitted to the motor shaft 410 to control the rotation speed of the cam 510, which in turn controls translation of the pressure plate 200. The cam 510 can be integrally formed with the motor shaft 410. In some embodiments, the cam 510 may be separately manufactured and fixedly coupled to the motor shaft 410.

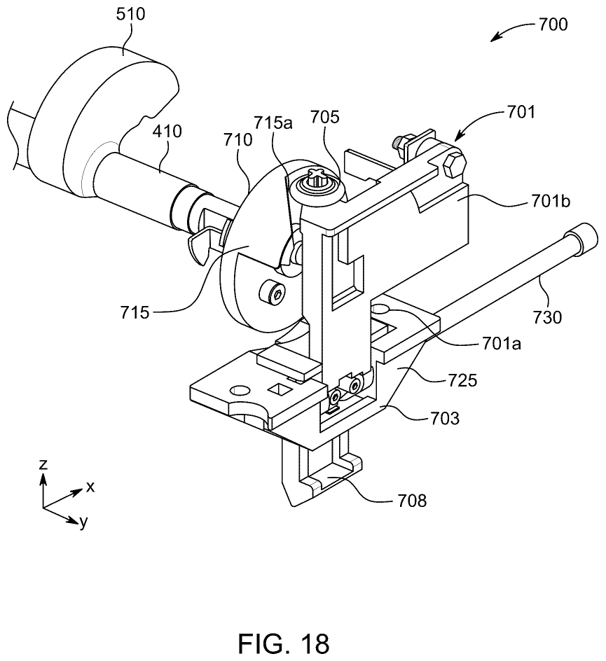

The motor shaft 410 can be an elongated shaft having a first end portion 411 and a second end portion 412 (see FIG. 5). The motor 400 can be coupled at the first end portion 411 of the motor shaft 410 and the latch assembly 700 can be coupled via a latch actuator 710 (see FIGS. 4 and 18), at the second end portion 412 of the motor shaft 410. Between the first end portion 411 and the second end portion 412 of the motor shaft 410, the cam 510 can be disposed. The first end portion 411 can include a stop 415 configured to stop a rotation of the motor shaft 410 when engaged with a corresponding stop element 416. The stop 415 can be a radially projecting portion formed on the shaft. The second end portion 412 can include flat portions 422 and holes configured to receive and fixedly couple a latch component (e.g., the latch actuator 710 in FIG. 4) of the latch assembly 700. In one embodiment, the flat portions 422 can facilitate assembling of the latch component in a desired orientation (e.g., aligning a profiled portion 715 of the latch actuator 710 with a portion of the follower engaging portions 511a-511d of the cam profile 511, as shown in FIG. 4). Accordingly, the distal end portion 412 can facilitate dual use of the motor shaft 410 for latching purposes and moving the pressure plate 200 by the cam 510, according to one embodiment.

In some embodiments, the motor shaft 410 can be supported by a first support 431 and a second support 432. The first support 431 can be disposed at the first end portion 411 and a second support 432 can be disposed between the cam 510 and the distal end portion 412. The supports 431 and 432 can include bearings to allow rotation of the motor shaft 410. The second support 432 can further include the stop element 416 to serve as a hard stop limit that can be placed at a predetermined angle with respect to a longitudinal axis of the motor shaft 410. The predetermined angle can be an angle determined relative to the follower engaging profile 511 of the cam 510 such that the motor 400 does not drive the cam 510 too far to cause the cam 510 from disengaging with the follower 520 when translating the pressure plate 200 (e.g., see FIG. 4). Accordingly, the stop element 416 can limit rotation of the motor shaft 410 when engaged with the stop 415.

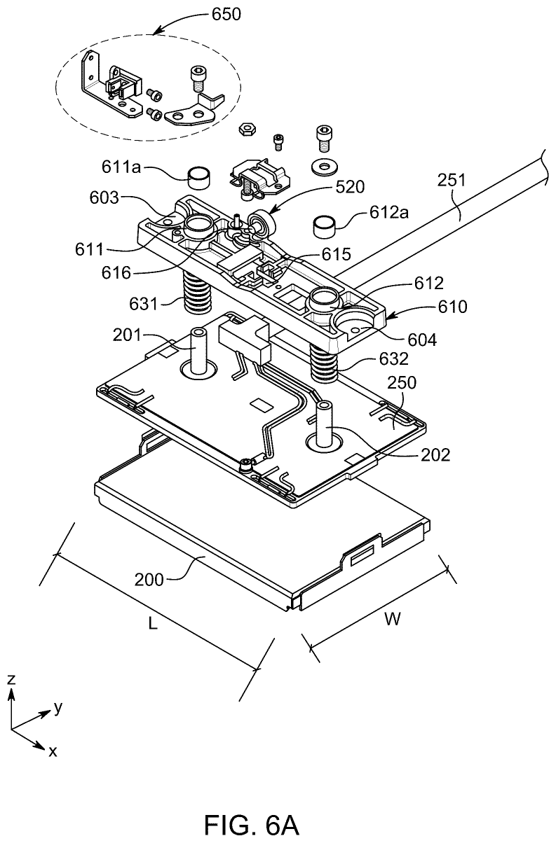

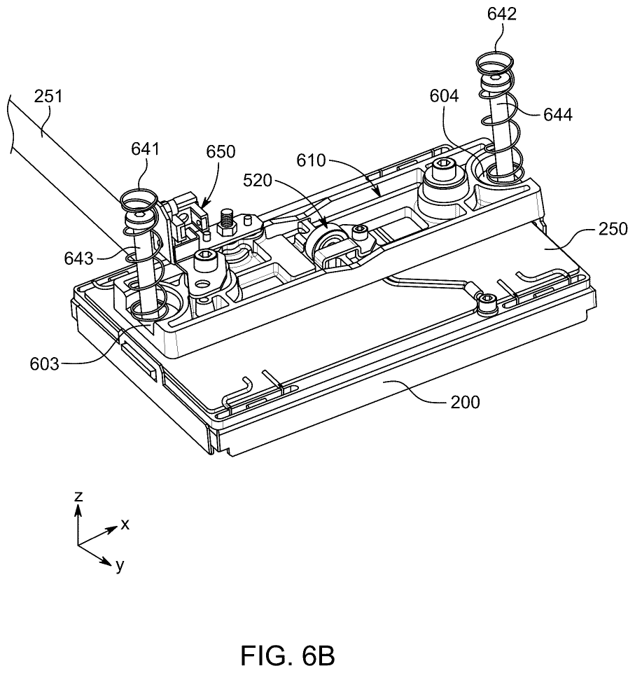

FIGS. 6A-6B illustrate exploded view and an assembled view of the compression bar assembly 600, respectively. The compression bar assembly 600 can include a compression bar 610 configured to receive the follower 520 and springs 631, 632 to apply pressure against a top surface of the pressure plate 200. The compression bar 610 can be an elongated plate sized to at least partially extend along a length L of the pressure plate 200.

The width of the compression bar 610 can be less than a width W of the of the pressure plate 200. The compression bar 610 can transfer point forces acting, via the follower 520, on the compression bar 610 and evenly distribute the forces on the pressure plate 200 so that an undersurface of the pressure plate 200 can evenly apply pressure on tops of the consumable (e.g., the consumable 310 in FIG. 1A).

In some embodiment, the compression bar 610 can include a follower slot 615 or other follower mounting features to receive the follower 520. The follower 520 can be a circular ring or a circular bearing. The follower 520 can be assembled in the follower slot 615 using a pin 616. The compression bar 610 can include guides 611 612, and bushings or bearings 611a, 612a at the ends of the elongated plate. The guides 611 and 612 can be configured to receive compression springs 631 and 632, respectively. The compression springs 631 and 632 can be pre-loaded springs to apply pressure on the pressure plate 200 when the follower 520 causes the compression bar 610 to move downward.

The compression bar 610 can include pockets 603 and 604 to receive an assembly of springs 641 and 642 and pins 643 and 644 (see FIG. 6B), respectively. The springs 641 and 642 can be return springs to urge the compression bar 610 to maintain an initial or a rest position and to maintain the contact between the follower 520 and the cam 510. The return springs 641 and 642 have substantially lower pull back force compared to the compression springs 631 and 632 to minimize any unnecessary loading requirements during the return.

In some embodiments, the pressure plate 200 can be coupled to a heater 250 to heat tops of the consumable. The heater 250 can be an electrical heater comprising resistive heating elements that can be activated by supply current via electrical wires 251. Guide posts 201 and 202 can be provided on the pressure plate 200 (see FIG. 6A) or the heater 250. The guide posts 201 and 202 can be received in the guides 611 and 612 to facilitate vertical alignment of the pressure plate 200 and/or the heater 250. The springs 631 and 632 can also be mounted around the guide posts 201 and 202 to help stabilize the compression bar 610 and to assist in distributing the force imposed by the pressure plate on the consumable and/or a thermal block situated underneath.

FIGS. 7A and 7B illustrate exploded views showing another variation of components in the lid 100. As shown, the lid 100 can include the cam assembly 500, a compression bar assembly 600B (similar to the compression bar assembly 600), and control board assembly 850. The compression bar assembly 600B includes a compression bar 610B that has a similar structure as the compression bar 610 with minor variations. Each of these assemblies can be coupled within the lid 100 to operate the compression bar 610B and the pressure plate 200. In one embodiment, as shown in FIGS. 7A and 7B the compression bar 610B can include guides 601 and 602 configured to engage with guide posts provided on the lid chassis 102 or the lid cover 101 to facilitate vertical alignment of the compression bar 610B when translating in the vertical direction. The control board assembly 850 can include a printed circuit board (PCB) 801 having memory storing instructions when executed to cause operations to actuate the motor 400 to latch/unlatch the lid 100 and to rotate the cam 510 to move the pressure plate 200 until a desired pressure is applied at the consumable. In some embodiments, a sensor 650 may be attached to the compression bar assembly 600 that can send a signal to the PCB 801 to indicate the predetermined pressure is reached so that the PCB 801 can stop rotation of the motor 400.

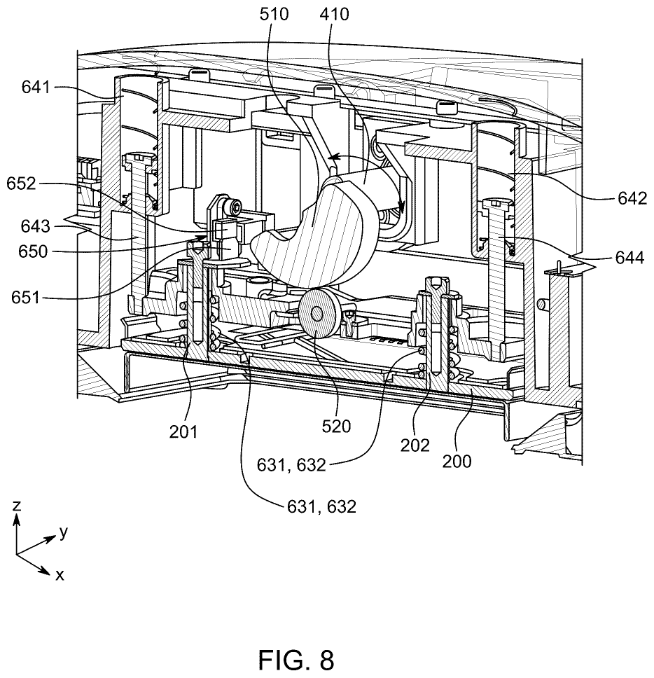

FIG. 8 illustrates a cross-section of a portion of the lid 100 comprising the compression bar assembly 600 and the cam 510 engaged with the follower 520. As the cam 510 rotates (e.g., in counter clockwise direction), the cam 510 pushes the follower 520 in a downward direction causing the compression bar 610 (in FIG. 6A-6B or 610B of FIGS. 7A-7B) and the pressure plate 200 to move in a downward direction. Once the pressure plate 200 presses against the tops of the consumables (not shown) the compression springs 631 and 632 exert pressure on a top surface of the pressure plate 200. In one embodiment, as shown in FIG. 8, a calibrated sensor 650 (also shown in FIG. 6A), or other sensors may be employed to determine whether the predetermined pressure (e.g., 75 lbs.) is reached so that the motor 400 can be stopped to stop rotation of the cam 510. The calibrated sensor 650 is vertically adjusted to calibrate the spring (e.g., 631, 632) loads. The calibrated sensor 650 can be configured to send a signal to a controller (e.g., PCB 801 in FIG. 7A) indicating a position at which the pre-determined pressure is applied by the pressure plate 200. For example, the calibrated sensor 650 can include a flag 651 and a trip detector 652. The calibrated sensor 650 can be installed at a pre-calibrated location on the compression bar 610, where the pre-calibrated location corresponds to a desired force or pressure to be exerted on the pressure plate 200. Until the flag 651 remains at or in the trip detector 652, it indicates desired pressure is not reached. The calibrated sensor 650 may also be referred as a clamp sensor, or another clamp sensor may be installed at the pressure plate 200 to trip when a pre-determined pressure is reached. After the compression bar 610 (in FIG. 6A-6B or 610B of FIG. 7A-7B) advances downward and the flag 651 is separated from the trip detector 652, it indicates the cam 510 in combination with the springs 631 and 632 can exert the desired pressure on the pressure plate 200. The calibrated sensor 650 can then send a signal to the PCB 801 (in FIG. 7A) to stop the motor 400 and further advancement of the cam 510. In some embodiments, additional sensors may be included, for example, a consumable detection sensor configured to detect whether a consumable is present in the compartment 304.

FIG. 9 is a front cross-section view of the lid 100 of the thermal cycler 10 illustrating different planes for adjusting height of the pressure plate 200. As shown, the planes may include a rest plane P0, a first plane P1, and a second plane P2. The rest plane P0 can correspond to an undersurface of the pressure plate 200 in rest position when the lid 100 is closed. The first plane P1 can correspond to tops of a first height consumables. In some embodiments, a distance between the rest plane P0 and the first plane P1 can be traversed by moving the follower 520 along the dwell portion 511a of the cam 510 (see FIG. 3). In some embodiments, a distance between the rest plane P0 and the first plane P1 can be traversed by moving the follower 520 along the first portion 511a and the second portion 511b of the cam 510 (see FIG. 3). In some embodiments, a distance between the first plane P1 and the second plane P2 can be traversed by moving the follower 520 along the third portion 511c and the fourth portion 511d of the cam 510 (see FIG. 3).

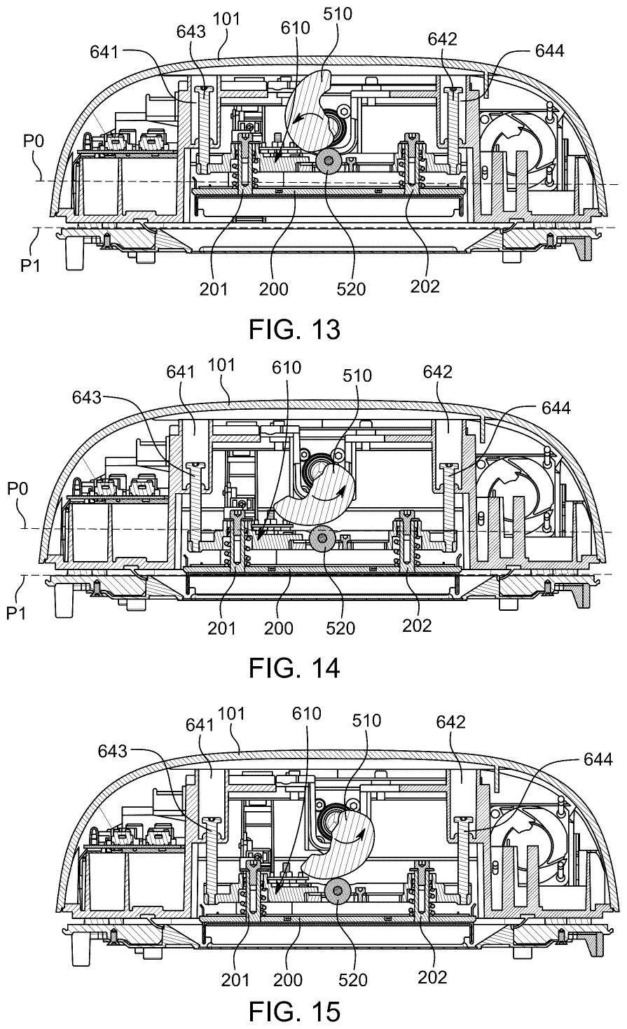

FIGS. 10-12 are cross-sections of a portion of the thermal cycler 10 that further illustrate positions of the cam 510 and the pressure plate 200 when the first height consumables (e.g., comprising 0.5 ml wells) are placed in the compartment 304 of the thermal cycler 10 (shown in FIG. 1A). In FIGS. 10-12, the undersurface of the pressure plate 200 moves from the rest plane P0 to the first plane P1. FIGS. 13-15 are cross-sections of a portion of the thermal cycler 10 that further illustrate positions of the cam 510 and the pressure plate 200 when the second height consumables (e.g., comprising 2 ml wells) are placed in the compartment 304 of the thermal cycler 10. In FIGS. 13-15, the undersurface of the pressure plate 200 moves from the rest plane P0 to the second plane P2.

FIG. 10 is a cross-section view of the lid 100 illustrating the cam 510 rotated to an initial position and the pressure plate 200 in a rest position. At the rest position, the dwell portion 51 la (see FIG. 3) of the cam 510 is in contact with the follower 520 and the undersurface of the pressure plate 200 is at the rest plane P0. Referring to FIG. 11, as the cam 510 is rotated, the second portion 511b (see also FIG. 3) of the cam 510 starts pushing the follower 520 downward until the undersurface of the pressure plate 200 reaches the first plane P1 and contacts the tops of the first height consumables. During first contact of the pressure plate 200 with the tops of the first height consumables, a predetermined pressure is not exerted on the tops. As such, the cam 510 is rotated further, as shown in FIG. 12, until a predetermined pressure (e.g., 75 lbs) is exerted on the tops of the first height consumables.

During such rotation, the clamping portion of the second portion 511b (see FIG. 3) of the cam 510 is engaged so that the predetermined pressure can be applied at a constant torque (e.g., same as a torque at a different height consumable) from the motor 400. During this clamping motion, the follower 520 can cause the compression bar 610 (or 610B) to move by a specified distance (e.g., less than 3 mm) so that the springs 631 and 632 exert pressure on the pressure plate 200. When the predetermined pressure is reached, the sensor 650 (see FIG. 7) can send signal to the motor 400 to stop the rotation of the cam 510.

FIG. 13 is a cross-section view of the lid 100 illustrating the cam 510 rotated further than shown in FIG. 12 so that the pressure plate 200 can be moved towards the second plane (e.g., P2 of the second height consumables). In FIG. 13, the dwell portion of the third portion 511c (see FIG. 3) of the cam 510 is in contact with the follower 520 and the undersurface of the pressure plate 200 is at the rest plane P1. During such dwell portion, the pressure plate 200 does not move or moves negligibly slightly (e.g., less than 0.5 mm). Referring to FIG. 14, as the cam 510 is rotated, the fourth portion 511d (see also FIG. 3) of the cam 510 starts pushing the follower 520 downward until the undersurface of the pressure plate 200 reaches the second plane P2 and contacts the tops of the second height consumables. During first contact of the pressure plate 200 with the tops of the second height consumables, a predetermined pressure is not exerted on the tops. As such, the cam 510 is rotated further, as shown in FIG. 15, until a predetermined pressure (e.g., 75 lbs) is exerted on the tops of the first height consumables. During such rotation, other clamping portion of the second portion 511b of the cam 510 is engaged so that the predetermined pressure can be applied at a constant torque (e.g., same as a torque at a different height consumable) from the motor 400. During this clamping motion, the follower 520 can cause the compression bar 610 (or 610B) to move by a specified distance (e.g., less than 3 mm) so that the springs 631 and 632 exert pressure on the pressure plate 200. When the predetermined pressure is reached, the sensor 650 (see FIG. 7) can send signal to the motor 400 to stop the rotation of the cam 510.

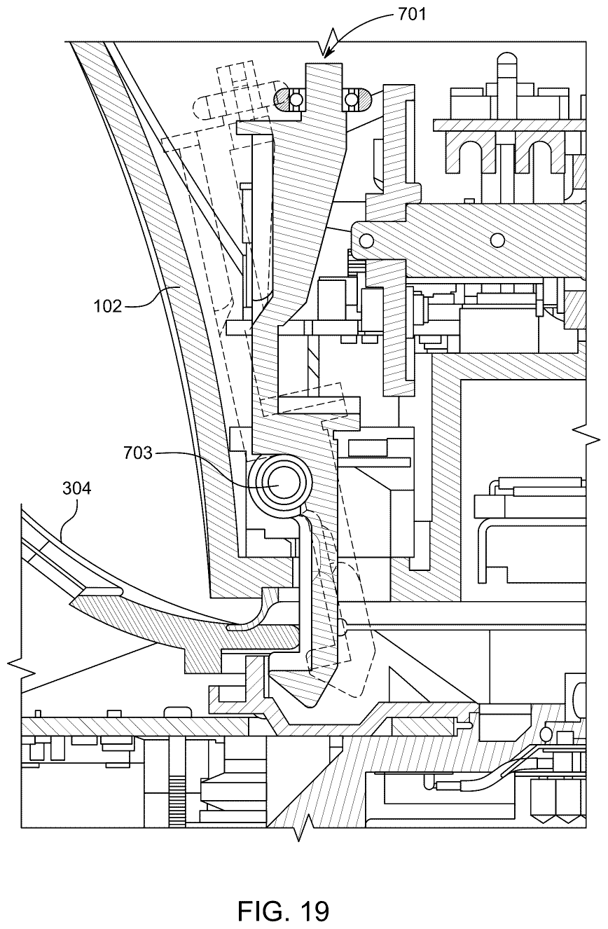

FIGS. 16-19 illustrate an example latch assembly 700 and its operation, according to some embodiments. The latch assembly 700 can include a latch 701 and a latch actuator 710, which cooperates with the latch 701 to lock/latch or unlock/unlatch the lid 100 from the base 300 (see FIG. 19). FIG. 16 is an exploded view of a portion of the latch assembly 700 showing the latch 701 and a latch wheel 705 coupleable to the latch 701. As shown in FIG. 16, the latch 701 can include an elongated portion 701a extending transversely in a vertical direction with respect to the motor shaft 410 and a pivot portion 703 about which the elongated portion 701a pivots.

The elongated portion 701a can include a first end 706, a second end 708, and a catch 709. The latch wheel 705 or appropriate follower feature to contact the ramp profile 715a can be disposed at the first end 706 and the catch 709 can be disposed at the second end 708. The pivot portion 703 can be between the first end 706 and the second end 708 of the elongated portion 701a. In one embodiment, the latch 701 can also include another elongated portion 701b extending perpendicular to the elongated portion 701a to form a L-shaped latch. This elongated portion 701b can be used to mount or support attaching means 725 for attaching the latch 701 to the lid chassis 102 or the lid cover 101.

In one embodiment, the latch wheel 705 can be configured to cooperate with the profiled portion 715 to cause the latch actuator 710 to be in a latched state or an unlatched state while the cam 510 is disengaged from the follower 520. For example, the first end of the latch 701 can include a mounting pin and the latch wheel 705 can be rotatably coupled (e.g., using a clip and washer 742) to the mounting pin. The latch wheel 705 can travel along the ramp profile 715a as the motor shaft 410 rotates in a clockwise direction causing the elongated portion 701a to pivot about the pivot portion 703 and move the catch 709 (e.g., along y-direction) so that the latch actuator 710 can be in the latched state or the unlatched state. FIG. 19 shows the pivoting action of the latch 701 and engagement and disengagement of the catch 709 from the base 300.

In one embodiments, shown in FIG. 16, the latch assembly 700 can further include a spring 722 that can be disposed at the pivot portion 703. The spring 722 can be a torsional spring. The spring 722 can pre-load the latch 701 to move the latch 701 in the latched state when the latch wheel 705 is disengaged from the profiled portion 715 (see FIG. 18). In the latched state, the follower engaging portion 511 of the cam 510 can engage with the follower 520.

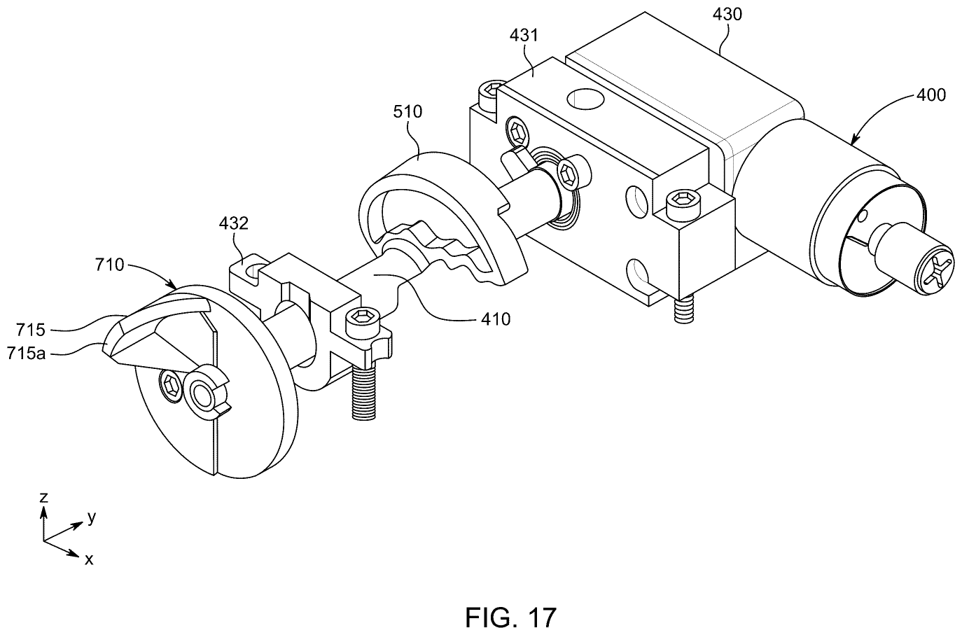

As shown in FIGS. 17 and 18, the latch actuator 710 can be coupled to the motor shaft 410 at the second end portion 412. The latch actuator 710 can include a profiled portion 715 extending axially (e.g., in y-direction) and radially at least partially along a peripheral surface of the latch actuator 710. The latch actuator 710 can be coupled to the motor shaft 410 such that the profiled portion 715 at least partially aligns with the follower engaging portion 511. The profiled portion 715 of the latch actuator has a ramp profile 715a (best seen in FIG. 18) extending axially away from the cam 510 and inclined with a center of rotation of the motor shaft 410. In one embodiment, as the motor shaft 410 rotates in the clockwise direction, the latch wheel 705 can travel along the ramp profile 715a towards an end of the profiled portion 715 away from the cam 510 causing elongated portion 701a to pivot and unlatch the catch 709. In the unlatched state, the spring 722 may be compressed and provide an opposing force. When the motor shaft 410 rotates in the counterclockwise direction, the latch wheel 705 can travel along the ramp profile 715a in the opposite direction (e.g., toward the cam 510) and the opposing force stored in the spring 722 can cause the latch 701 to pivot to cause latching of the catch 709 (see FIG. 19).

It can be understood, that the present disclosure is not limited to the pivoting type of locking mechanism and other types of locking mechanism such as sliding type can be used.

In some embodiments, the automatic latch and unlatching action of the lid 100 is achieved by rotation of the motor. However, if the motor 400 is in a stuck or failed state when the lid 100 is latched, the lid 100 needs to be opened manually. In one embodiment, the manual operation can be performed by manually rotating the motor 400 using a screwdriver. For example, the motor 400 can be provided with a slotted head 402 (see FIG. 5) which can be engaged with a screwdriver to manually rotate the motor shaft 410 to unlatch the lid 100.

In another example, a manual opening mechanism can be provided at the latch assembly 700. For example, referring back to FIGS. 16 and 18, the latch assembly 700 can further include a rod 730 couplable at the pivot portion 703 to manually pivot the latch 701 to an unlatched state. The rod 730 can extend in a direction (e.g., x-direction) perpendicular to the vertical direction (e.g., z-direction) and a longitudinal axis (e.g., y-direction) of the motor shaft 410. An end portion of the rod 730 can be sized to pass through a slot or a hole at the pivot portion 702 and through the spring 722. The rod 730 can be secured at the pivot portion 703 using fastening means such as screws 723. At an opposite end, the rod 730 can include a tool receiving slot 732 to receive a tool (e.g., a screwdriver) for rotating the rod. The tool receiving slot 732 can be accessed through the latch access hole 102c, shown in FIGS. 1 and 20-21.

FIGS. 20 and 21 illustrate an operation for manually opening of a closed lid 100 using a screwdriver 800 having a head shape corresponding to the slot 732 of the rod 730, as an example. As shown, the head of the screwdriver 800 can be inserted through the latch access hole 102c to engage with the slot 732 of the rod 730. Once engaged, the screwdriver can be rotated (e.g., in counterclockwise direction) to cause the latch 701 to pivot and unlatch the lid 100. Once unlatched, the lid 100 can be opened.

In one or more embodiments of the present disclosure, an instrument for receiving multiple height consumables comprises a consumable compartment configured to receive first height consumables having a first height or second height consumables having a second height, tops of the first height consumables defining a first plane when the first height consumable are received within the consumable compartment, and tops of the second height consumables defining a second plane when the second height consumables are received within the consumable compartment; and a lid for opening or closing the consumable compartment. The lid comprises a motor; a pressure plate; a compression bar having a first side and a second side opposite to the first side, wherein the first side is coupled to the pressure plate; and a cam and a follower assembly disposed on the second side of the compression bar. The cam is drivably coupled to the motor and the follower is coupled to the compression bar to induce translation of the compression bar when engaged with the cam.

The cam comprises a cam profile with a follower engaging portion configured to adjust a height of the pressure plate within the consumable compartment between the first plane and the second plane and drive the compression bar to apply a pre-determined pressure at the first plane, the second plane, or a plane therebetween. Optionally, the cam profile is a continuous profile comprising a first portion, a second portion following the first portion. The first portion and the second portion are configured to engage with the follower during adjusting of the height of the pressure plate to the first plane. Optionally, the first portion of the cam profile is a dwell portion extending from approximately 0° from a start of the cam profile to approximately 50° from the start of the cam profile, wherein a radius of curvature of the first portion gradually increases from start of the cam profile to an end of the first portion such that as the follower travels from the start of the first portion to end of the first portion, the pressure plate one of: remains stationary; or moves less than 2 mm towards the first plane.

Optionally, the second portion of the cam profile extends from approximately 50° from the start of the cam profile to approximately 90° from the start of the cam profile, wherein a radius of curvature of the second portion gradually increases such that as the follower travels along the second portion, the pressure plate moves towards the first plane and contacts the tops of the first height consumables defining the first plane. Optionally, the second portion further comprises a clamping portion, wherein the clamping portion comprises a radius of curvature and/or a pressure angle defined as a function of a specified torque of the motor.

Optionally, the clamping portion operates at a constant torque applied by the motor to cause the pressure plate to travel further than the first plane and apply the pre-determined pressure at the first height consumables. Optionally, the cam profile further comprises a third portion configured to cause the pressure plate to translate at a faster rate than translation caused by the first portion or the second portion. Optionally, the third portion of the cam profile extends from approximately 90° from the start of the cam profile to approximately 165° from the start of the cam profile, wherein a radius of curvature of the third portion gradually increases such that as the follower travels along the third portion, the pressure plate moves towards the second plane and comes in contact with the second plane. Optionally, the third portion has a pressure angle greater than a pressure angle of the first portion and/or the second portion to allow a faster travel rate of the follower to cover a distance between the first plane and the second plane compared to an earlier travel rate before reaching the first plane. Optionally, the cam profile further comprises a fourth portion extending from approximately 165° from the start of the cam profile to approximately 300° from the start of the cam profile, wherein the fourth portion has varying pressure angles and radius of curvatures to apply an approximately constant torque at the second plane or planes between the first plane and the second plane.

Optionally, the fourth portion further comprises a fifth portion having an approximately constant radius to avoid the follower disengaging from the cam, wherein the fifth portion spans between approximately 295° to 300°. Optionally, the cam profile is configured to move the pressure plate by (i) a first distance from a rest plane of the pressure plate at a first rate and at a pre-determined torque provided by the motor, and (ii) a second distance from the rest plane at a second rate and at the pre-determined torque provided by the motor so as to enable the instrument to receive the first height consumables or the second height consumables.

Optionally, the cam profile comprises a follower non-engaging portion where the follower is disengaged from the cam while the cam rotates. Optionally, the instrument further comprises a calibrated sensor configured to send a signal indicating a position at which the pre-determined pressure is applied by the pressure plate; and a controller configured to control, based on the signal from the calibrated sensor, deactivation of the motor to prevent the cam from further rotating and advancing the pressure plate. Optionally, the cam is coupled to a motor shaft extending perpendicular to a translation direction of the pressure plate.

Optionally, the motor shaft further comprises a stop located along the motor shaft to prevent the cam from rotating beyond the follower engaging profile when the pressure plate is traveling beyond the second plane. Optionally, the cam profile comprises radii of curvatures and pressure angles configured to operate the cam and the follower at approximately a constant torque provided by the motor. Optionally, the lid further comprises a heater coupled to the pressure plate to heat a surface of the pressure plate facing the consumable compartment. Optionally, the lid further comprises: a latch operably coupled to the cam and the follower assembly such that a motor shaft actuates the latch prior to moving the pressure plate by the cam and follower assembly. Optionally, the instrument further comprises: a latch actuator configured to move the latch between a latched position to an unlatched position.

The latch actuator and the cam are mounted on same motor shaft and driven by same motor. Optionally, the instrument is a thermal cycler used for Polymerase Chain Reaction (PCR).

Optionally, the cam profile is optimized to minimize required torque input from the motor and to accommodate multiple consumable heights while providing for a minimized height profile of the cam.

In one or more embodiments of the present disclosure, an instrument comprises a consumable compartment; and a lid for opening or closing the consumable compartment. The lid comprises a motor; a motor shaft comprising a first end and a second end, wherein the first end is driveably coupled to the motor; a cam and a follower assembly, wherein the cam is coupled to the motor shaft between the first end and the second end, wherein the cam is driven by the motor to cause translation of the follower, wherein the cam comprises a cam profile having a follower engaging portion and a follower non-engaging portion; a latch actuator coupled to the motor shaft at the second end, wherein the latch actuator comprises a profiled portion extending axially and radially at least partially along a peripheral surface of the latch actuator, wherein the latch actuator is coupled to the motor shaft such that the profiled portion at least partially aligns with the follower engaging portion; and a latch comprising a latch wheel. The latch wheel is configured to cooperate with the profiled portion to cause the latch to be in an unlatched state while the cam is disengaged from the follower. Optionally, the latch comprises an elongated portion extending transversely in a vertical direction with respect to the motor shaft and a pivot portion about which the elongated portion pivots. Optionally, the elongated portion comprises a catch, a first end, a second end, wherein the latch wheel is disposed at the first end and the catch is disposed at the second end, wherein the pivot portion is between the first end and the second end. Optionally, the profiled portion of the latch actuator has a ramp profile extending axially away from the cam and inclined with a center of rotation of the motor shaft, wherein the latch wheel is configured to travel along the ramp profile causing the elongated portion to pivot about the pivot portion and move the catch so that the latch is in the latched state or the unlatched state. Optionally, the instrument further comprises: a rod coupled at the pivot portion of the latch to manually pivot the latch. Optionally, the rod comprises a tool receiving slot to receive a tool for rotating the rod. Optionally, the instrument further comprises a spring disposed at the pivot portion to pre-load the latch to move the latch in the latched state when the latch wheel is disengaged from the profiled portion. Optionally, the spring is a torsional spring. Optionally, the latch wheel disengages from the profiled portion of the latch to move the latch to the locked state, wherein in the locked state, the follower engaging portion of the cam profile engages with the follower. Optionally, in the locked state of the latch, the follower engaging portion of the cam profile is configured to move the follower between a first distance and a second distance.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

While certain embodiments have been described, these embodiments have been presented by way of example only, and are not intended to limit the scope of the present disclosures. Indeed, the novel methods, apparatuses and systems described herein can be embodied in a variety of other forms; furthermore, various omissions, substitutions and changes in the form of the methods, apparatuses and systems described herein can be made without departing from the spirit of the present disclosures. The accompanying claims and their equivalents are intended to cover such forms or modifications as would fall within the scope and spirit of the present disclosures.

All references, including publications, patent applications, and patents, cited herein are hereby incorporated by reference to the same extent as if each reference were individually and specifically indicated to be incorporated by reference and were set forth in its entirety herein.

1. An instrument for receiving multiple height consumables, the instrument comprising:
a consumable compartment configured to receive first height consumables having a first height or second height consumables having a second height, tops of the first height consumables defining a first plane when the first height consumable are received within the consumable compartment, and tops of the second height consumables defining a second plane when the second height consumables are received within the consumable compartment; and
a lid for opening or closing the consumable compartment, the lid comprising:
a motor;
a pressure plate;
a compression bar having a first side and a second side opposite to the first side, wherein the first side is coupled to the pressure plate; and
a cam and a follower assembly disposed on the second side of the compression bar, wherein the cam is drivably coupled to the motor and the follower is coupled to the compression bar to induce translation of the compression bar when engaged with the cam,
wherein the cam comprises a cam profile with a follower engaging portion configured to adjust a height of the pressure plate within the consumable compartment between the first plane and the second plane and drive the compression bar to apply a pre-determined pressure at the first plane, the second plane, or a plane therebetween.

2. The instrument of claim 1, wherein the cam profile is a continuous profile comprising a first portion, a second portion following the first portion, and
wherein the first portion and the second portion are configured to engage with the follower during adjusting of the height of the pressure plate to the first plane.

3. The instrument of claim 2, wherein the first portion of the cam profile is a dwell portion extending from approximately 0° from a start of the cam profile to approximately 50° from the start of the cam profile, wherein a radius of curvature of the first portion gradually increases from start of the cam profile to an end of the first portion such that as the follower travels from the start of the first portion to end of the first portion, the pressure plate one of: remains stationary; or moves less than 2 mm towards the first plane.

4. The instrument of claim 2, wherein the second portion of the cam profile extends from approximately 50° from the start of the cam profile to approximately 90° from the start of the cam profile, wherein a radius of curvature of the second portion gradually increases such that as the follower travels along the second portion, the pressure plate moves towards the first plane and contacts the tops of the first height consumables defining the first plane.

5. The instrument of claim 3, wherein the second portion further comprises a clamping portion, wherein the clamping portion comprises a radius of curvature and/or a pressure angle defined as a function of a specified torque of the motor.

6. The instrument of claim 5, wherein the clamping portion operates at a constant torque applied by the motor to cause the pressure plate to travel further than the first plane and apply the pre-determined pressure at the first height consumables.

7. The instrument of claim 2, wherein the cam profile further comprises a third portion configured to cause the pressure plate to translate at a faster rate than translation caused by the first portion or the second portion.

8. The instrument of claim 7, wherein the third portion of the cam profile extends from approximately 90° from the start of the cam profile to approximately 165° from the start of the cam profile, wherein a radius of curvature of the third portion gradually increases such that as the follower travels along the third portion, the pressure plate moves towards the second plane and comes in contact with the second plane.

9. The instrument of claim 8, wherein the third portion has a pressure angle greater than a pressure angle of the first portion and/or the second portion to allow a faster travel rate of the follower to cover a distance between the first plane and the second plane compared to an earlier travel rate before reaching the first plane.

10. The instrument of claim 8, wherein the cam profile further comprises a fourth portion extending from approximately 165° from the start of the cam profile to approximately 300°from the start of the cam profile, wherein the fourth portion has varying pressure angles and radius of curvatures to apply an approximately constant torque at the second plane or planes between the first plane and the second plane.

11. The instrument of claim 10, wherein the fourth portion further comprises a fifth portion having an approximately constant radius to avoid the follower disengaging from the cam, wherein the fifth portion spans between approximately 295° to 300°.

12. The instrument of claim 1, wherein the cam profile is configured to move the pressure plate by (i) a first distance from a rest plane of the pressure plate at a first rate and at a pre-determined torque provided by the motor, and (ii) a second distance from the rest plane at a second rate and at the pre-determined torque provided by the motor so as to enable the instrument to receive the first height consumables or the second height consumables.

13. The instrument of claim 1, wherein the cam profile comprises a follower non-engaging portion where the follower is disengaged from the cam while the cam rotates.

14. The instrument of claim 1, further comprises:
a calibrated sensor configured to send a signal indicating a position at which the pre-determined pressure is applied by the pressure plate; and
a controller configured to control, based on the signal from the calibrated sensor, deactivation of the motor to prevent the cam from further rotating and advancing the pressure plate.

15. The instrument of claim 1, wherein the cam is coupled to a motor shaft extending perpendicular to a translation direction of the pressure plate, and wherein the motor shaft further comprises a stop located along the motor shaft to prevent the cam from rotating beyond the follower engaging profile when the pressure plate is traveling beyond the second plane.

16. (canceled)

17. (canceled)

18. (canceled)

19. The instrument of claim 1, wherein the lid further comprises:
a latch operably coupled to the cam and the follower assembly such that a motor shaft actuates the latch prior to moving the pressure plate by the cam and follower assembly.

20. (canceled)

21. (canceled)

22. (canceled)

23. An instrument comprising:
a consumable compartment; and
a lid for opening or closing the consumable compartment, the lid comprising:
a motor;
a motor shaft comprising a first end and a second end, wherein the first end is driveably coupled to the motor;
a cam and a follower assembly, wherein the cam is coupled to the motor shaft between the first end and the second end, wherein the cam is driven by the motor to cause translation of the follower, wherein the cam comprises a cam profile having a follower engaging portion and a follower non-engaging portion;
a latch actuator coupled to the motor shaft at the second end, wherein the latch actuator comprises a profiled portion extending axially and radially at least partially along a peripheral surface of the latch actuator, wherein the latch actuator is coupled to the motor shaft such that the profiled portion at least partially aligns with the follower engaging portion; and
a latch comprising a latch wheel, wherein the latch wheel is configured to cooperate with the profiled portion to cause the latch to be in an unlatched state while the cam is disengaged from the follower.

24. The instrument of claim 23, wherein the latch comprises an elongated portion extending transversely in a vertical direction with respect to the motor shaft and a pivot portion about which the elongated portion pivots; and
wherein the elongated portion comprises a catch, a first end, a second end, wherein the latch wheel is disposed at the first end and the catch is disposed at the second end, wherein the pivot portion is between the first end and the second end.

25. (canceled)

26. The instrument of claim 25, wherein the profiled portion of the latch actuator has a ramp profile extending axially away from the cam and inclined with a center of rotation of the motor shaft, wherein the latch wheel is configured to travel along the ramp profile causing the elongated portion to pivot about the pivot portion and move the catch so that the latch is in a latched state or the unlatched state.

27. The instrument of claim 24, further comprises:
a rod coupled at the pivot portion of the latch to manually pivot the latch, wherein the rod comprises a tool receiving slot to receive a tool for rotating the rod; and
a spring disposed at the pivot portion to pre-load the latch to move the latch in the latched state when the latch wheel is disengaged from the profiled portion.

28. (canceled)

29. (canceled)

30. (canceled)

31. (canceled)

32. (canceled)
